(19) United States
(12) Patent Application Publication
(10) Pub. No.: US 2026/0334530 A1
(43) Pub. Date: Oct. 29, 2026

(54) AEROSOL-GENERATING ARTICLE

(71) Applicant: Philip Morris Products S.A., Neuchatel (CH)

(72) Inventors: Matteo BOLOGNA, Lausanne (CH); Bruno Christian Joseph CHASSOT, Auvernier (CH); Onur DAYIOGLU, Neuchâtel (CH); Marie Rose Danielle FARINE, Sugiez (CH); Jerome UTHURRY, Neuchâtel (CH)

(73) Assignee: Philip Morris Products S.A., Neuchatel (CH)

(21) Appl. No.: 19/136,959

(22) PCT Filed: Dec. 21, 2023
(86) PCT No.: PCT/EP2023/087248

§ 371 Date: Jun. 9, 2025

(30) Foreign Application Priority Data
Dec. 23, 2022 (EP) 22216422

(51) Int. Cl. A24D 1/20

(52) U.S. Cl. CPC A24D 1/20

(57) ABSTRACT

An aerosol-generating article for an aerosol-generating device to generate an inhalable aerosol is provided, the aerosol-generating article including: a planar upper layer and a planar lower layer vertically spaced from each other by a separation height defined in a z direction; and an air inlet, an air outlet, and an airflow passage extending between the air inlet and the air outlet, the airflow passage being defined between the planar upper layer and the planar lower layer and having a width defined in a y direction, the width of the airflow passage being greater than 1 mm, the separation height being less than 2 mm, and the aerosol-generating article having a resistance to draw (RTD) of less than 20 mm H₂O in a direction of the airflow passage.

The present disclosure relates to an aerosol-generating article comprising an aerosol-forming substrate.

A typical aerosol-generating article may appear similar to a conventional cigarette. For example, such an aerosol-generating article may be a substantially cylindrical article comprising an aerosol-forming substrate and other components such as mouthpiece filter element, all wrapped in a cigarette paper. Dimensions of typical aerosol-generating articles are often similar to the dimensions of conventional cigarettes.

Research has shown that, in such a typical aerosol-generating article comprising a plug of aerosol-forming substrate, a significant portion of the plug of aerosol-forming substrate may not be sufficiently heated to form an aerosol during use. This is undesirable since this portion of the plug of aerosol-forming substrate contributes to the cost of manufacture and transport of the aerosol-generating article, but does not contribute to the aerosol delivered to an end user. This may be the case regardless of the way in which the aerosol-forming substrate is heated, for example regardless of whether a resistive or inductive heater is used and regardless of whether the plug of aerosol-forming substrate is heated from the inside or the outside.

It is an aim of the present disclosure to provide an aerosol-generating article, in which a greater portion of an aerosol-forming substrate of the aerosol-generating article is sufficiently heated to form an aerosol during use.

According to the present disclosure, there may be provided an aerosol-generating article comprising an aerosol-forming substrate for producing an aerosol, the aerosol-generating article being a planar aerosol-generating article having a base defined by a length extending in an x direction, a width extending in a y direction, and a height extending in a z direction. The aerosol-generating article may comprise a planar upper layer and a planar lower layer vertically spaced from each other by a separation height defined in the z direction. The aerosol-generating article may comprise an air inlet, an air outlet, and an airflow passage extending between the air inlet to the air outlet, the airflow passage may be defined between the planar upper layer and the planar lower and have a width defined in a y direction. The width of the airflow passage may greater than 1 millimetre and the separation height may be less than 5 millimetres.

According to the present disclosure, there may be provided an aerosol-generating article for use with an aerosol-generating device to generate an inhalable aerosol. The aerosol-generating article may comprise a planar upper layer and a planar lower layer vertically spaced from each other by a separation height defined in a z direction. The aerosol-generating article may comprise an air inlet, an air outlet, and an airflow passage extending between the air inlet to the air outlet, the airflow passage may be defined between the planar upper layer and the planar lower layer. The airflow passage may have a width defined in a y direction. The width of the airflow passage may be greater than 1 millimetre and the separation height may be less than 5 millimetres.

The aerosol-generating article of the present disclosure may be generally flat and thin, it may be substantially planar and have a small separation between the planar upper layer and the planar lower layer. The provision of a generally flat and thin aerosol-generating article provides for rapid and efficient heating of aerosol-forming substrate in the aerosol-generating article and improved uniformity in through-thickness heating. Advantageously, the maximum distance between a portion of aerosol-forming substrate and a heater for heating the aerosol-generating article is reduced and aerosol-forming material in the aerosol-generating article may be heated more quickly.

Advantageously, the width of the airflow passage is relatively large to allow for adequate airflow through the aerosol-generating article despite the article being generally flat and thin, for example the aerosol-generating article having a small separation between a planar upper layer and a planar lower layer. The provision of a generally wide airflow passage may allow a user to comfortably puff on the aerosol-generating article, in use, and may provide the user with a desired amount of aerosol despite a small separation height of the aerosol-generating article. In particular, the wide airflow passage may allow air to flow relatively slowly through the aerosol-generating article, to provide improved contact between the air flow and aerosol-forming substrate of the aerosol-forming article, enhanced mixing of generated aerosol and air in the air flow passage, and improved aerosolisation.

The airflow passage may have a passage height defined in the z direction. The passage height may be equal to the separation height.

The planar upper layer and planar lower layer may be parallel.

The separation height may be a maximum vertical distance between the planar upper layer and the planar lower layer.

Preferably, the separation height is less than 4 millimetres, for example less than 3 millimetres, for example less than 2 millimetres, for example less than 1 millimetres.

The separation height may be greater than 0.1 millimetres, for example greater than 0.2 millimetres, for example greater than 0.5 millimetres.

According to the present disclosure, there may be provided an aerosol-generating article comprising an aerosol-forming substrate for producing an aerosol, the aerosol-generating article comprising a substantially planar upper surface defined by a length extending in an x direction and a width extending in a y direction, and a substantially planar lower surface defined by a length extending in an x direction and a width extending in a y direction. The substantially planar upper surface and the substantially planar lower surface may be vertically spaced from each other by a height defined in a z direction.

The planar upper layer may comprise an upper external surface and the planar lower layer may comprise a lower external surface. The upper external surface may be the substantially planar upper surface and the lower external surface of the planar lower layer may be the planar lower surface of the aerosol-generating article. The upper external surface and the lower external surface are vertically spaced by a surface-to-surface height, wherein the surface-to-surface height is less than 5 millimetres.

Preferably, the surface-to-surface height is less than 4.1 millimetres, for example less than 3.1 millimetres, for example less than 2.1 millimetres, for example less than 1.1 millimetres.

Preferably, the width of the airflow passage is greater than 1.2 millimetres, for example greater than 1.5 millimetres, for example greater than 2 millimetres.

The width of the airflow passage may be less than 3 millimetres, for example less than 2.8 millimetres, for example less than 2.5 millimetres.

Preferably, the airflow passage may have a cross-sectional area defined in the y-z direction, wherein the cross-sectional sectional area of the airflow passage is greater than 0.1 millimetres squared and less than 15 millimetres squared, for example, greater than 1 millimetres squared and less than 12.5 millimetres squared.

The airflow passage may have a length defined in an x direction, wherein the length is greater than 15 millimetres and less than 40 millimetres, for example greater than 20 millimetres and less than 30 millimetres, for example 26 millimetres.

The width of the airflow passage may be uniform along the length of the airflow passage. The airflow passage may have a volume of greater than 1.5 millimetres cubed, less than 600 millimetres cubed, greater than 15 millimetres cubed less than 40 millimetres cubed, greater than 20 less than 30, less than 187.5 millimetres cubed, less than 450 millimetres cubed.

The separation height may be is no more than 5 times the width of the airflow passage, for example no more than 4 times the width of the airflow passage, for example no more than 3 times the width of the airflow passage.

The width of the airflow passage may be an average width of the airflow passage defined in the y direction across the separation height.

The width of the airflow passage may be uniform along the separation height, for example the cross-section of the airflow passage defined in the y, z direction is square or rectangular.

The aerosol-generating article may have an article width defined in the y direction, wherein the width of the airflow passage is at least 0.1 times the article width, for example at least 0.2 times the article width, for example at least 0.3 times the article width.

The aerosol-generating article may comprise a single airflow passage. Alternatively, the aerosol-generating article may comprise two or more airflow passages. For example, the aerosol-generating article may comprise a plurality of airflow passages.

The air flow passage may be formed of a single airflow channel extending between the air inlet and the air outlet.

Alternatively, a plurality of discrete air flow channels may together form the airflow passage, wherein each channel extends from a channel air inlet to a channel air outlet.

Each a channel air inlet of the plurality of discrete air flow channels may together form the air inlet of the aerosol-generating article. Each of the channel air outlets of the plurality of discrete air flow channels may together form the air outlet of the aerosol-generating article.

Each discrete air flow channel may have a channel width, wherein the width of the airflow passage is a cumulative width, which is a sum of each of the channel widths.

Each discrete air flow channel may have a channel internal volume, wherein the volume of the airflow passage is a cumulative volume, which is a sum of each of the channel internal volumes.

Preferably, the planar upper layer, the planar lower layer, or both the planar upper layer and the planar lower layer comprise an aerosol forming substrate.

Aerosol-generating articles according to the present disclosure may preferably be substantially flat articles or substantially planar articles. Such articles have a large base area relative to the volume of the article. Advantageously, a larger base area may provide greater surface area for heating by a planar heater of an aerosol-generating device. Advantageously, a smaller height may allow a smaller temperature gradient or difference across the height of the aerosol-generating article during heating. For example, where the base of the aerosol-generating article is in contact with, and heated by, a planar heater, there may be a smaller temperature difference between the base and an upper surface opposing the base if the spacing, or height, between the base and the upper surface is smaller. Advantageously, this may allow heating of a greater proportion of the aerosol-forming substrate of the aerosol-generating article to a temperature at which an aerosol is released, whilst minimising the risk of burning the hottest portion of the substrate closest to the heater. Alternatively, or in addition, this may reduce a time required to heat the aerosol-forming substrate sufficiently to release an aerosol.

The aerosol-generating article according to any of the aspects disclosed herein may have an airflow path extending through the aerosol-generating article. The airflow path may be defined through the air inlet, the air outlet, and the airflow passage. The aerosol-generating article may have an airflow path defined through the aerosol-generating article in an x/y plane from one side of the aerosol-generating article to the other side of the aerosol-generating article. The aerosol-generating article preferably has a resistance to draw (RTD) of less than 20 millimetre H₂O, in the direction of the airflow path, preferably in the direction of the airflow passage.

The aerosol-generating article may have a resistance to draw (RTD) of less than 10 millimetre H2O, in the direction of the airflow path, preferably in the direction of the airflow passage. Preferably, the aerosol-generating article has a RTD of less than 20 millimetre H₂O, for example less than 10 millimetre H₂O, in at least one direction in an x/y plane of the aerosol-generating article. An aerosol-generating article with a low resistance air-flow path may allow for superior air-flow management and allow aerosol to be extracted more efficiently from the aerosol-generating article and guided to a user.

Unless otherwise specified, the resistance to draw (RTD) is measured in accordance with ISO 6565-2015. The RTD refers to the pressure required to force air through the full length of a component, such as the aerosol-generating article. The terms “pressure drop” or “draw resistance” of a component or article may also refer to the “resistance to draw”. Such terms generally refer to the measurements made in accordance with ISO 6565-2015 and are normally carried out at under test at a volumetric flow rate of about 17.5 millilitres per second at the output or downstream end of the measured component at a temperature of about 22 degrees Celsius, a pressure of about 101 kPa (about 760 Torr) and a relative humidity of about 60%.

The aerosol-generating article according to any of the aspects disclosed herein may comprise substantially planar upper and lower surfaces. A vertical separation between the substantially planar upper and lower surfaces may define a height (for example, a z dimension, for example a surface-to-surface height) of the aerosol-generating article. An air flow channel may be defined between the substantially planar upper and lower surfaces. The height of the aerosol-generating article may be less than 5 millimetres, for example between 1.5 millimetres and 5 millimetres, for example between 1.5 millimetres and 4 millimetres, for example between 1.5 millimetres and 3 millimetres, for example between 1.5 millimetres and 2 millimetres. One or both of the substantially planar upper and lower surfaces may comprise an aerosol-forming substrate. The aerosol-generating article may comprise upper and lower layers, at least one of the upper and lower layers comprising or consisting of aerosol-forming substrate, the upper layer forming the substantially planar upper surface and the lower layer forming the substantially planar lower surface.

The aerosol-generating article may further comprise an intermediate layer arranged between the first planar layer and the second planar layer.

Preferably, the air flow passage is defined through the intermediate layer.

The intermediate layer may comprise, or consist of, a corrugated element or corrugated layer.

Corrugations of the corrugated element or corrugated layer may be defined by a corrugation wavelength and a corrugation amplitude. The corrugation wavelength may be between 1 mm and 10 mm, for example between 1.5 mm and 8 mm, for example between 2 mm and 6 mm, for example between 2.5 mm and 5 mm, for example between 3 mm and 4 mm. The corrugation amplitude may be between 0.1 mm and 5 mm, for example between 0.2 mm and 4 mm, for example between 0.5 mm and 3 mm, for example between 0.7 mm and 2 mm, for example about 1 millimetre, about 1.2 millimetres, or about 1.5 millimetres. The corrugation amplitude is the same as the thickness, for example in the z dimension, of the corrugated element or layer.

The separation height may be equal to the corrugation amplitude.

Longitudinal channels formed by longitudinally extending corrugations of the corrugated element or corrugated layer may extend in a planar direction of the first planar layer and the second planar layer. The longitudinal channels may extend along in an x/y plane between a distal end of the aerosol-generating article and a proximal end of the aerosol-generating article.

A plurality of longitudinally extending channels may be defined by corrugations between the first planar layer and the corrugated layer, and between the corrugated layer and the second planar layer.

The plurality of longitudinally extending channels preferably extend in the x direction.

The plurality of longitudinally extending channels preferably extend between the air inlet and the air outlet.

Each of the plurality of longitudinally extending channels may from a discrete air flow channel, such that the aerosol-forming article may comprise a plurality of discrete air flow channels.

The plurality of discrete air flow channels may together form the airflow passage, wherein each channel extends from a channel air inlet to a channel air outlet. Each a channel air inlet of the plurality of discrete air flow channels may together form the air inlet of the aerosol-generating article. Each of the channel air outlets of the plurality of discrete air flow channels may together form the air outlet of the aerosol-generating article.

Each discrete air flow channel may have a channel width, wherein the width of the airflow passage is a cumulative width, which is a sum of each of the channel widths.

Each discrete air flow channel may have a channel internal volume, wherein the volume of the airflow passage is a cumulative volume, which is a sum of each of the channel internal volumes.

The channel width of each discrete air flow channel of the plurality of discrete air flow channels may be an average width of the channel. The channel width of each discrete air flow channel of the plurality of discrete air flow channels may be half the wavelength of the channel. The channel width of each discrete air flow channel of the plurality of discrete air flow channels may be uniform along the length of each discrete air flow channel.

Each discrete air flow channel of the plurality of discrete air flow channels may have a channel cross-sectional area defined in the z-y direction. The airflow passage cross-sectional area may be a cumulative cross-sectional area of all of the channel cross-sectional areas of each of the plurality of discrete air flow channels.

Each discrete air flow channel of the plurality of discrete air flow channels may have a channel length. The channel length may be equal to the length of the airflow passage defined in an x direction.

The corrugated layer may be a corrugated sheet of material.

At least one of the first planar layer, the second planar layer and the corrugated layer may comprise or consist of an aerosol-forming material. The aerosol-forming material may be a homogenised tobacco material.

One or more of the first planar layer, the intermediate layer and the second planar layer may comprise or consist of aerosol-forming material.

One or both of the first planar layer and the second planar layer may comprise or consist of aerosol-forming material, the first planar layer being free of aerosol-forming material.

The intermediate layer may comprise or consist of aerosol-forming material, the first planar layer and the second planar layer being free of aerosol-forming material.

The intermediate layer may be fixed relative to at least one of the upper layer and lower layer by an adhesive. For example, the adhesive may comprise guar gum. The adhesive may comprise an aerosol-forming material such as homogenised tobacco slurry.

A porous element may be located in at least one of the longitudinally extending channels.

The use of a corrugated structure in the aerosol-generating article may advantageously allow the production of an aerosol-generating article that has extremely low RTD while still being sufficiently rigid to for a user to handle. Further, use of a corrugated structure may allow a low density, low RTD, aerosol-generating article to be produced using high speed production methods similar to those used for production of corrugated cardboard.

The width of the airflow passage may be an average width of the airflow passage defined in the y direction across the separation height.

According to the present disclosure, there may be provided an aerosol-generating article comprising a first planar layer, a second planar layer, and a corrugated layer arranged between the first planar layer and the second planar layer. The first planar layer may be the planar upper layer as described herein and the planar lower layer may be the second planar layer as described herein. At least one of the first planar layer, the second planar layer and the corrugated layer may comprise or consist of an aerosol-forming substrate. The first planar layer may be a planar upper layer and the second planar layer may be a planar lower layer. The planar upper layer and the planar lower layer may be vertically spaced from each other by a separation height defined in a z direction. The aerosol-generating article may comprise an air inlet, an air outlet, and an airflow passage extending between the air inlet to the air outlet, the airflow passage may be defined between the planar upper layer and the planar lower and have a width defined in a y direction. The width of the airflow passage may greater than 1 millimetre and the separation height may be less than 5 millimetres.

The use of a corrugated structure, for example the corrugated layer, in the aerosol-generating article may advantageously allow the production of an aerosol-generating article that has extremely low RTD while still being sufficiently rigid to for a user to handle. Further, use of a corrugated structure may allow a low density, low RTD, aerosol-generating article to be produced using high speed production methods similar to those used for production of corrugated cardboard.

The aerosol-generating article may further comprise a planar frame positioned between the first planar layer and the second planar layer. An upper surface may define an external surface of the first planar layer and a lower surface may define an external surface of the second planar layer. The planar frame may define a cavity. An air flow path may be defined through the aerosol-generating article in an x/y plane, the air flow path extending through the cavity.

The cavity may have a height, defined in the z direction equal to the separation height and the air flow passage height.

The airflow path may be at least partially defined by the frame. The frame may comprise an inlet airflow channel and an outlet airflow channel, the inlet airflow channel configured to permit a flow of air into the cavity and the outlet airflow channel configured to permit a flow of air to exit the cavity. The inlet airflow channel and the outlet airflow channel may be defined on opposing ends of the frame. The inlet air-flow channel may be defined in a first width edge of the frame and the outlet airflow channel defined in a second width edge of the frame. The inlet airflow channel may comprise the air inlet and the outlet airflow channel may comprise the air outlet. The airflow passage may be defined between the air inlet and the air outlet and extend through the cavity.

The airflow passage may be formed of a single airflow channel including the cavity and extending between the air inlet and the air outlet.

The cavity may have a width, defined in the y direction equal to the airflow passage width.

The cavity may have a length, defined in the x direction equal to the airflow passage length.

The planar upper layer, the planar lower layer, or both the planar upper layer and the planar lower layer may comprise an aerosol forming substrate.

According to the present disclosure, there may be provided an aerosol-generating article, the aerosol-generating article comprising: a first planar external surface, a second planar external surface, a cavity, a frame positioned between the first planar external surface and the second planar external surface, the frame at least partially defining the cavity, an aerosol-forming substrate positioned between the first planar external surface and the second planar external surface, and an air inlet and an air outlet, and an airflow passage extending between the air inlet and the air outlet through the cavity. The first planar external surface and the second planar external surface may be vertically spaced from each other by a separation height defined in a z direction. The airflow passage may have a width defined in a y direction. The width of the airflow passage may greater than 1 millimetre and the separation height may be less than 5 millimetres.

The frame may comprise a peripheral wall at least partially circumscribing or encircling the cavity. The frame may comprise a peripheral wall wholly circumscribing or encircling the cavity.

The aerosol-generating article may comprise a first planar external layer and a second planar external layer, in which the first planar external layer forms the first planar external surface, and the second planar external layer forms the second planar external surface. Optionally, at least one of the first planar external layer, the second planar external layer, and the frame may comprise or consist of aerosol-forming substrate.

The cavity may be substantially empty.

Aerosol-forming substrate may be positioned within the cavity.

A corrugated layer may be positioned within the cavity.

The aerosol-generating article of any of the aspects of the present disclosure may have a length (for example, an x dimension) of between 10 millimetres and 100 millimetres, or between 10 millimetres and 50 millimetres, for example between 12 millimetres and 30 millimetres, for example between 14 millimetres and 26 millimetres, for example between 16 millimetres and 24 millimetres, for example between 18 millimetres and 22 millimetres, for example about 18 millimetres, or about 19 millimetres, or about 20 millimetres, or about 21 millimetres, or about 22 millimetres.

The aerosol-generating article may have a width (for example, a y dimension) of between 5 millimetres and 20 millimetres, for example between 8 millimetres and 18 millimetres, for example between 10 millimetres and 16 millimetres, for example between 11 millimetres and 15 millimetres, for example between 12 millimetres and 14 millimetres, for example about 13 millimetres.

The aerosol-generating article may have a height (for example, a z dimension) of between 1 millimetre and 10 millimetres, for example between 1.2 millimetres and 8 millimetres, for example between 1.4 millimetres and 7 millimetres, for example between 1.6 millimetres and 6 millimetres, for example between 1.7 millimetres and 5 millimetres, for example about 1.7 millimetres, or about 4.5 millimetres, or about 2 millimetres, or about 3 millimetres, or about 4 millimetres.

The aerosol-generating article of any of the aspects of the present disclosure when viewed in plan may have a shape defining a polygon, a quadrilateral (for example, a rectangle or a square), oval, or circle, or a combination thereof. Where the aerosol-generating article comprises substantially planar upper and lower surfaces, one or both of the upper and lower surfaces when viewed in plan may have a shape defining a polygon, a quadrilateral (for example, a rectangle or a square), an oval, a circle, or a combination thereof. A perimeter of the aerosol-generating article when viewed in plan may be formed of a plurality of straight sides, a plurality of curved sides, or a combination of straight and curved sides. Where the aerosol-generating article comprises substantially planar upper and lower surfaces, a perimeter of one or both of the upper and lower surfaces when viewed in plan may have a shape defining a polygon, a quadrilateral (for example, a rectangle or a square), an oval, a circle, or a combination thereof.

The aerosol-generating article may consist entirely of aerosol-forming substrate. Alternatively, the aerosol-forming substrate may be one of a plurality of component parts of the aerosol-generating article.

The aerosol-forming substrate may comprise nicotine. Nicotine may be present in the form of a tobacco material or may be in the form of a nicotine extract.

Preferably, the aerosol-forming substrate comprises, or consists of, homogenised tobacco material, for example a reconstituted tobacco material or a cast leaf tobacco material.

The aerosol-forming substrate may comprise, or consist of, a solid aerosol-forming material. The aerosol-forming substrate may comprise a liquid aerosol-forming material, for example a liquid aerosol-forming material retained within a porous matrix. The aerosol-forming substrate may comprise a gel aerosol-forming material.

The aerosol-forming substrate may comprise one or more aerosol-formers. Suitable aerosol-formers are well known in the art and include, but are not limited to, one or more aerosol-formers selected from: polyhydric alcohols, such as propylene glycol, polyethylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. It may be particularly preferable for the aerosol-former to be or comprise glycerine.

The aerosol-forming substrate may comprise at least 1, 2, 5, 10, or 15 weight percent aerosol-former. The aerosol-forming substrate may comprise greater than 15 weight percent aerosol-former, for example greater than 20 weight percent, or greater than 25 weight percent, or greater than 30 weight percent, or greater than 40 weight percent, or greater than 50 weight percent aerosol-former.

The aerosol-forming substrate may comprise less than or equal to 30 percent by weight of aerosol former, less than or equal to 25 percent by weight of aerosol former, or less than or equal to 20 percent by weight of aerosol former. That is, the aerosol-forming substrate may have an aerosol former content of less than or equal to 30 percent by weight, less than or equal to 25 percent by weight, or less than or equal to 20 percent by weight.

The aerosol-forming substrate may comprise between 1 percent and 30 percent by weight of aerosol former, between 1 percent and 25 percent by weight of aerosol former, or between 1 percent and 20 percent by weight of aerosol former.

The aerosol-forming substrate may comprise between 5 percent and 30 percent by weight of aerosol former, between 5 percent and 25 percent by weight of aerosol former, or between 5 percent and 20 percent by weight of aerosol former.

The aerosol-forming substrate may comprise between 10 percent and 30 percent by weight of aerosol former, between 10 percent and 25 percent by weight of aerosol former, or between 10 percent and 20 percent by weight of aerosol former.

The aerosol-forming substrate may comprise between 15 percent and 30 percent by weight of aerosol former, between 15 percent and 25 percent by weight of aerosol former, or between 15 percent and 20 percent by weight of aerosol former.

The aerosol-forming substrate may comprise at least 50 percent by weight of aerosol former, at least 60 percent by weight of aerosol former, or at least 70 percent by weight of aerosol former.

The aerosol-forming substrate may comprise less than or equal to 85 percent by weight of aerosol former, less than or equal to 80 percent by weight of aerosol former, or less than or equal to 75 percent by weight of aerosol former.

The aerosol-forming substrate may comprise between 50 percent and 85 percent by weight of aerosol former, between 50 percent and 80 percent by weight of aerosol former, or between 50 percent and 75 percent by weight of aerosol former.

The aerosol-forming substrate may comprise between 60 percent and 85 percent by weight of aerosol former, between 60 percent and 80 percent by weight of aerosol former, or between 60 percent and 75 percent by weight of aerosol former.

The aerosol-forming substrate may comprise between 70 percent and 85 percent by weight of aerosol former, between 70 percent and 80 percent by weight of aerosol former, or between 70 percent and 75 percent by weight of aerosol former.

The aerosol-forming substrate may comprise nicotine. The aerosol-forming material may comprise natural nicotine, or synthetic nicotine, or a combination of natural nicotine and synthetic nicotine.

The aerosol-forming substrate may comprise at least 0.5 percent by weight of nicotine, at least 1 percent by weight of nicotine, at least 1.5 percent by weight of nicotine, or at least 2 percent by weight of nicotine. That is, the aerosol-forming substrate may have a nicotine content of at least 0.5 percent by weight, at least 1 percent by weight, at least 1.5 percent by weight, or at least 2 percent by weight.

The aerosol-forming substrate may comprise one or more cannabinoid compounds such as one or more of: tetrahydrocannabinol (THC), tetrahydrocannabinolic acid (THCA), cannabidiol (CBD), cannabidiolic acid (CBDA), cannabinol (CBN), cannabigerol (CBG), cannabigerol monomethyl ether (CBGM), cannabivarin (CBV), cannabidivarin (CBDV), tetrahydrocannabivarin (THCV), cannabichromene (CBC), cannabicyclol (CBL), cannabichromevarin (CBCV), cannabigerovarin (CBGV), cannabielsoin (CBE), cannabicitran (CBT). It may be preferable that the cannabinoid compound is CBD or THC. It may be particularly preferable that the cannabinoid compound is CBD.

The aerosol-forming substrate may comprise one or more flavourants. The one or more flavourants may comprise one or more of: one or more essential oils such as eugenol, peppermint oil and spearmint oil; one or both of menthol and eugenol; one or both of anethole and linalool; and a herbaceous material. Suitable herbaceous material includes herb leaf or other herbaceous material from herbaceous plants including, but not limited to, mints, such as peppermint and spearmint, lemon balm, basil, cinnamon, lemon basil, chive, coriander, lavender, sage, tea, thyme, and caraway. The one or more flavourants may comprise a tobacco material.

The aerosol-forming substrate may have a moisture content of about 5 to 25%, preferably of about 7 to 15%, at final product state. For example, the aerosol-forming substrate may be a homogenised tobacco material with a moisture of about 5 to 25%, preferably of about 7 to 15%, at final product state.

The aerosol-forming substrate may comprise tobacco leaf; for example about 15 to 45%, preferably of about 20 to 35% of a blend of tobacco leaf, incorporating at least one of the following tobacco types: bright tobacco; dark tobacco; aromatic tobacco. Tobacco material such as tobacco leaf is preferably ground and graded to a particle size of about 100 to 380 mesh, preferably of about 170 to 320 mesh.

“Tobacco type” means one of the different varieties of tobacco, for example based on the distinct curing process that the tobacco undergoes before it is further processed in a tobacco product.

Examples of bright tobaccos are Flue-Cured Brazil, Indian Flue-Cured, Chinese Flue-Cured, US Flue-Cured such as Virginia tobacco, and Flue-Cured from Tanzania.

Examples of aromatic tobaccos are Oriental Turkey, Greek Oriental, semi-oriental tobacco but also Fire Cured, US Burley, such as Perique, and Rustica.

Examples of dark tobacco are Dark Cured Brazil Galpao, Burley Malawi or other African Burley, Sun Cured or Air Cured Indonesian Kasturi.

The aerosol-forming substrate may comprise Cellulose fibres. For example, the aerosol-forming substrate may comprise about 1 to 15% of cellulose fibres, preferably of about 3 to 7% of cellulose fibres. Preferably, cellulose fibres may have a length of about 10 to 250 μm, preferably of about 10 to 120 μm.

The aerosol-forming substrate may comprise organic fibres such as non-tobacco fibres, or tobacco fibres. For example, the aerosol-forming substrate may comprise about 5 to 20%, preferably about 7 to 15% of tobacco fibres. Tobacco fibres are preferably derived from stems and/or or stalks, graded to fibres of a length of about 10 to 350 μm, preferably of about 10 to 180 μm. The aerosol-forming substrate may comprise about 10 to 30 %, preferably of about 15 to 25%, of a non-tobacco organic fibre. For example, organic fibres may derive from cellulose, cotton, wood, tea botanical varieties as sub-products, and sub-processed waste, the tea industry. Organic fibres are preferably of a length of about 10 to 400 μm, preferably of about 10 to 200 μm.

The aerosol-forming substrate may comprise a binder. For example, the aerosol-forming substrate may comprise about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. A preferable binder is guar.

The aerosol-forming substrate may comprise an organic botanical glycerite. For example, the aerosol-forming substrate may comprise about 15 to 55 %, preferably of about 20 to 35 %, of botanicals such as Clove, Echinacea sp., Fennel, Ginger, Hawthorn berry, Elderberry, Monarda, Mullein leaves, Nettle, Plantain, Turmeric, Yarrow, and compounds of those.

The aerosol-forming substrate may comprise organic botanical extracts. For example, the aerosol-forming substrate may comprise about 1 to 15 %, preferably of about 2 to 7 %, of any of the previously referred botanicals, as well as menthol (dl-Menthol, C10H200, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

The aerosol-forming substrate may comprise botanical essential oils, for example about 0.5 to 5 %, preferably of about 1 to 3 %, of a botanical essential oil, for example a botanical essential oil such as of palm, coconut, and wooden-based essential oils.

The aerosol-forming substrate preferably comprises an aerosol-former, for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di- or triacetate; and aliphatic esters of mono-, di- or polycarboxylic acids, such as dimethyls of those.

According to the present disclosure there may be provided an aerosol-generating system comprising the aerosol-generating article as described herein and an aerosol-generating device. The aerosol generating device may be configured to engage with, and generate an aerosol from, the aerosol-generating article. The aerosol-generating device may comprise a heater configured to heat aerosol-forming material of the aerosol-generating article.

As used herein, the term “aerosol-generating article” may refer to an article able to generate, or release, an aerosol.

As used herein, the term “aerosol-forming substrate” may refer to a substrate capable of releasing an aerosol or volatile compounds that can form an aerosol. Such volatile compounds may be released by heating the aerosol-forming substrate. An aerosol-forming substrate may comprise an aerosol-forming material. An aerosol-forming substrate may be adsorbed, coated, impregnated, or otherwise loaded onto a carrier or support. An aerosol-forming substrate may conveniently be part of an aerosol-generating article or smoking article.

As used herein, the term “aerosol-generating device” may refer to a device for use with an aerosol-generating article to enable the generation, or release, of an aerosol.

As used herein, the term “aerosol generating system” refers to a combination of an aerosol-generating device and one or more aerosol-forming articles for use with the device. An aerosol-generating system may include additional components, such as a charging unit for recharging an on-board electric power supply in an electrically operated or electric aerosol-generating device.

As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-forming substrate or aerosol-generating article.

As used herein with reference to the invention, the term “nicotine”, is used to describe nicotine, nicotine base or a nicotine salt.

As used herein with reference to the invention, the terms “proximal”, “distal”, “upstream” and “downstream” are used to describe the relative positions of components, or portions of components, of the aerosol-generating article.

As used herein, the term “longitudinal” refers to the direction corresponding to the main longitudinal axis of the aerosol-generating article, which extends between the upstream and downstream ends of the aerosol-generating article. During use, air may be drawn through the aerosol-generating article in the longitudinal direction.

As used herein, the term “sheet” denotes a laminar element having a width and length substantially greater than the thickness thereof. The width of a sheet may be greater than 10 mm, preferably greater than 20 mm or 30 mm. In certain embodiments, sheets of material for use in forming aerosol-forming substrates as described herein may have a thickness of between 10 μm and about 1000 μm, for example between 10 μm and about 300 μm.

As used herein, the term “homogenised tobacco material” encompasses any tobacco material formed by the agglomeration of particles of tobacco material. Sheets or webs of homogenised tobacco material are formed by agglomerating particulate tobacco obtained by grinding or otherwise powdering of one or both of tobacco leaf lamina and tobacco leaf stems. In addition, homogenised tobacco material may comprise a minor quantity of one or more of tobacco dust, tobacco fines, and other particulate tobacco by-products formed during the treating, handling and shipping of tobacco. The sheets of homogenised tobacco material may be produced by casting, extrusion, paper making processes or other any other suitable processes known in the art.

The term “cast leaf” is used herein to refer to a product made by a casting process that is based on casting a slurry comprising plant particles (for example, clove particles or tobacco particles and clove particles in a mixture) and a binder (for example, guar gum) onto a supportive surface, such as a belt conveyor, drying the slurry and removing the dried sheet from the supportive surface. An example of the casting or cast leaf process is described in, for example, U.S. Pat. No. 5,724,998 for making cast leaf tobacco. In a cast leaf process, particulate plant materials are produced by pulverizing, grinding, or comminuting parts of the plant. The particles produced from one or more plants are mixed with a liquid component, typically water, to form a slurry. Other components in the slurry may include fibres, a binder and an aerosol former. The particulate plant materials may be agglomerated in the presence of the binder. The slurry is cast onto a supportive surface and dried into a sheet of homogenized plant material. Preferably, homogenized plant material used in articles according to the present invention may be produced by casting. Such homogenized plant material may comprise agglomerated particulate plant material.

As used herein, resistance to draw is expressed with the units of pressure “mm H₂O” or “mm WG” or “mm of water gauge” and may be measured in accordance with ISO 6565:2002.

The invention is defined in the claims. However, below there is provided a non-exhaustive list of non-limiting examples. Any one or more of the features of these examples may be combined with any one or more features of another example, embodiment, or aspect described herein.

Ex1. An aerosol-generating article for use with an aerosol-generating device to generate an inhalable aerosol, the aerosol-generating article comprising:
a planar upper layer and a planar lower layer vertically spaced from each other by a separation height defined in a z direction; and
an air inlet, an air outlet, and an airflow passage extending between the air inlet and the air outlet, the airflow passage being defined between the planar upper layer and the planar lower and having a width defined in a y direction,
wherein the width of the airflow passage is greater than 1 millimetre and the separation height is less than 5 millimetres.

Ex2. The aerosol-generating article according to example Ex1, wherein the airflow passage has a passage height defined in the z direction and the passage height is equal to the separation height.

Ex3. The aerosol-generating article according to example Ex1 or Ex2, wherein the planar upper layer and planar lower layer are parallel.

Ex4. The aerosol-generating article according to any preceding example, wherein the separation height is a maximum vertical distance between the planar upper layer and the planar lower layer.

Ex 5. The aerosol-generating article according to any preceding example, wherein the planar upper layer comprises a upper external surface and the planar lower layer comprises a lower external surface, the upper external surface and the lower external surface are vertically spaced by a surface-to-surface height, wherein the surface-to-surface height is less than 5 millimetres.

Ex 6. The aerosol-generating article according to any preceding example, wherein the separation height is less than 4 millimetres, for example less than 3 millimetres, for example less than 2 millimetres, for example less than 1 millimetres.

Ex7. The aerosol-generating article according to any preceding example, wherein the separation height is greater than 0.1 millimetres, for example greater than 0.2 millimetres, for example greater than 0.5 millimetres.

Ex8. The aerosol-generating article according to any preceding example, wherein the width of the airflow passage is greater than 1.2 millimetres, for example greater than 1.5 millimetres, for example greater than 2 millimetres.

Ex9. The aerosol-generating article according to any preceding example, wherein the width of the airflow passage is less than 3 millimetres, for example less than 2.8 millimetres, for example less than 2.5 millimetres.

Ex10. The aerosol-generating article according to any preceding example, wherein the airflow passage has a cross-sectional area defined in the y, z direction, wherein the cross-sectional sectional area of the airflow passage is greater than 0.1 millimetres squared and less than 15 millimetres squared, for example, greater than 1 millimetres squared and less than 12.5 millimetres squared.

Ex11. The aerosol-generating article according to any preceding example, wherein the airflow passage has a length defined in an x direction, wherein the length is greater than 15 millimetres and less than 40 millimetres, for example greater than 20 millimetres and less than 30 millimetres, for example 26 millimetres.

Ex12. The aerosol-generating article according to example Ex11, wherein the width of the airflow passage is uniform along the length of the airflow passage.

Ex13. The aerosol-generating article according to any preceding example, wherein the airflow passage has a volume of greater than 1.5 millimetres cubed, less than 600 millimetres cubed, greater than 15 millimetres cubed less than 40 millimetres cubed, greater than 20 less than 30, less than 187.5 millimetres cubed, less than 450 millimetres cubed.

Ex14. The aerosol-generating article according to any preceding example, wherein the aerosol-generating article has a resistance to draw (RTD) of less than 20 millimetre H₂O, for example less than 10 millimetre H₂O, in the direction of the airflow passage.

Ex15. The aerosol-generating article according to any preceding example, wherein the separation height is no more than 5 times the width of the airflow passage, for example no more than 4 times the width of the airflow passage, for example no more than 3 times the width of the airflow passage.

Ex16. The aerosol-generating article according to any preceding example, wherein the width of the airflow passage is the average width of the airflow passage defined in the y direction across the separation height.

Ex17. The aerosol-generating article according to any preceding example, wherein the width of the airflow passage is uniform along the separation height, for example the cross-section of the airflow passage defined in the y, z direction is square or rectangular.

Ex18. The aerosol-generating article according to any preceding example, wherein the aerosol-generating article has an article width defined in the y direction, wherein the width of the airflow passage is at least 0.1 times the article width, for example at least 0.2 times the article width, for example at least 0.3 times the article width.

Ex19. The aerosol-generating article according to any preceding example, wherein the air flow passage is formed of a single airflow channel extending between the air inlet and the air outlet.

Ex20. The aerosol-generating article according to any preceding example, wherein a plurality of discrete air flow channels together form the airflow passage, wherein each channel extends from a channel air inlet to a channel air outlet.

Ex21. The aerosol-generating article according to example Ex20, wherein each of the channel air inlets together form the air inlet of the aerosol-generating article and each of the channel air outlets together form the air outlet of the aerosol-generating article.

Ex22. The aerosol-generating article according to example Ex20 or Ex21, wherein each discrete air flow channel has a channel width, wherein the width of the airflow passage is a cumulative width of each of the channel widths.

Ex23. The aerosol-generating article according to any one of examples Ex20 to Ex22, wherein each discrete air flow channel has a channel internal volume, wherein the volume of the airflow passage is a cumulative volume of each of the channel internal volumes.

Ex24. The aerosol-generating article according to any preceding example, wherein the planar upper layer, the planar lower layer, or both the planar upper layer and the planar lower layer comprise an aerosol forming substrate.

Ex25. An aerosol-generating system comprising the aerosol-generating article according to any preceding claim and an aerosol-generating device, the aerosol generating device being configured to engage with, and generate an aerosol from, the aerosol-generating article.

Examples will now be further described with reference to the figures in which:

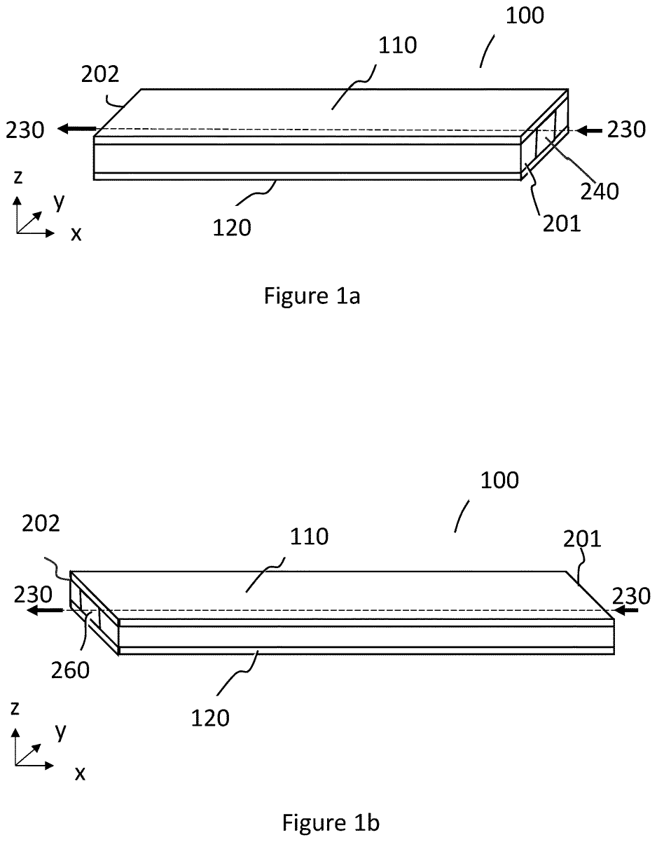

FIG. 1a is a perspective side view of an aerosol-generating article according to a first embodiment of the present disclosure;

FIG. 1b is an alternate perspective side view of an aerosol-generating article of FIG. 1a;

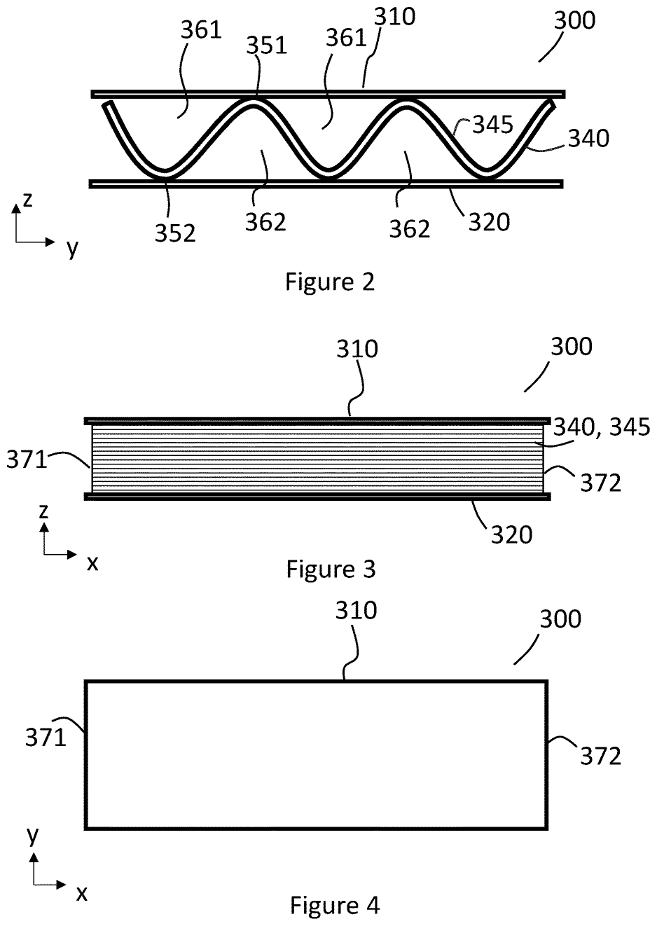

FIG. 2 is a schematic end view of an aerosol-generating article according to a second embodiment of the present disclosure;

FIG. 3 is a schematic side view of the aerosol-generating article of FIG. 2;

FIG. 4 is a schematic plan view of the aerosol-generating article of FIG. 2;

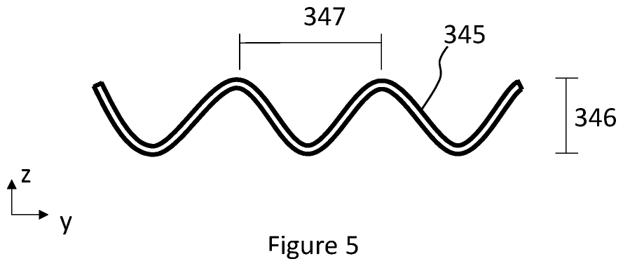

FIG. 5 shows a schematic illustration of a corrugated element as used in the aerosol-generating article of FIG. 2;

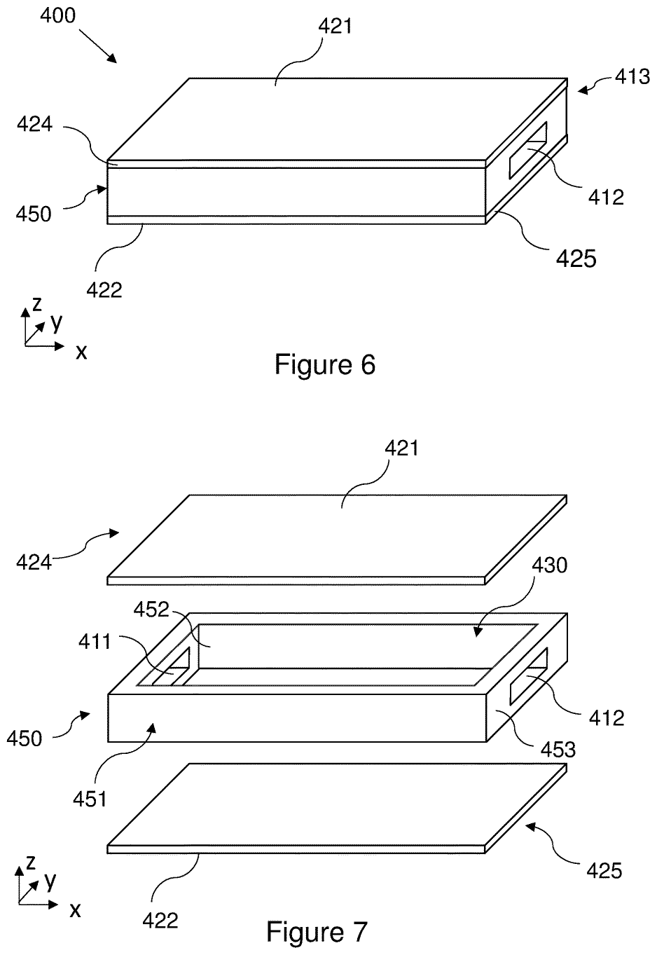

FIG. 6 shows a perspective view of an aerosol-generating article according to a third embodiment of the present disclosure;

FIG. 7 shows an exploded perspective view of the aerosol-generating article of FIG. 6;

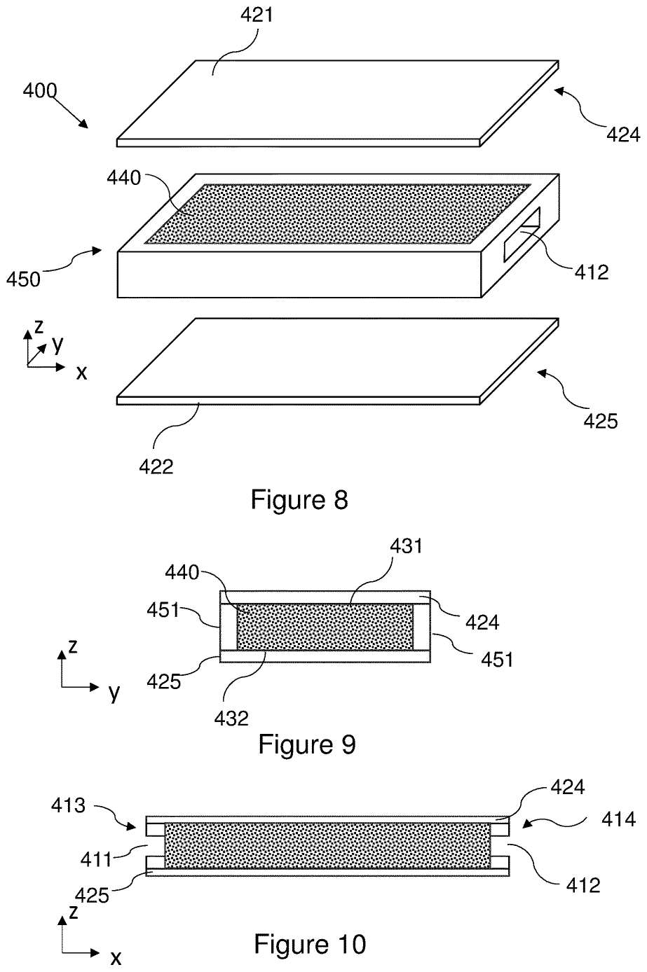

FIG. 8 shows a further exploded perspective view of the aerosol-generating article of FIG. 6;

FIG. 9 shows a schematic transverse cross-sectional view of the aerosol-generating article of FIG. 6;

FIG. 10 shows a schematic longitudinal cross-sectional view of the aerosol-generating article of FIG. 6;

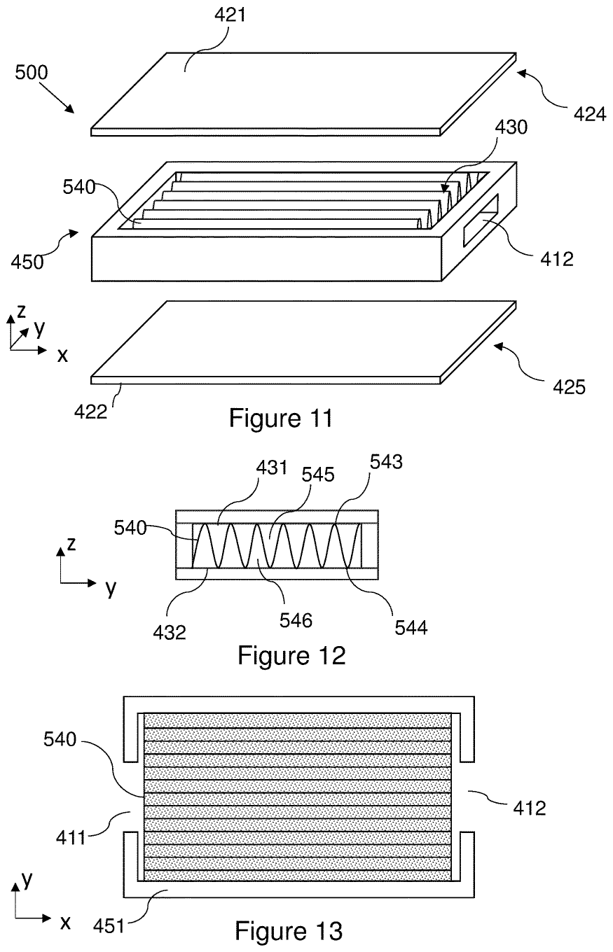

FIG. 11 shows an exploded perspective view of an aerosol-generating article according to a fourth embodiment of the present disclosure;

FIG. 12 shows a schematic transverse cross-sectional view of the aerosol-generating article of FIG. 11;

FIG. 13 shows a schematic lateral cross-sectional view of the aerosol-generating article of FIG. 11.

FIGS. 1a and 1b illustrate perspective side views of an aerosol-generating article 100 according to a first embodiment of the present disclosure. The aerosol-generating article 100 has a planar upper layer 110 and a planar lower layer 120.

The aerosol-generating article 100 comprises an aerosol-forming substrate (not shown). The aerosol-generating article 100 is suitable for use with an aerosol-generating device to generate an inhalable aerosol. In one embodiment, the aerosol-generating article 100 may consist substantially of aerosol-forming substrate. In another embodiment, the aerosol-forming substrate may be one of a plurality of component parts of the aerosol-generating article 100. The aerosol-forming substrate may be enclosed within an interior of the aerosol-generating article 100.

The aerosol-forming substrate may at least partially define an exterior of the aerosol-generating article 100; for example, one or both of the first and second planar layers 110, 120 may comprise or consist of aerosol-forming substrate.

A suitable aerosol-forming substrate may be homogenised tobacco.

The aerosol-generating article comprises a planar upper layer 110 extending in a first plane and a planar lower layer 120 extending in a second plane, the second plane being parallel to and spaced from the first plane. The planar upper layer and the planar lower layer are vertically spaced from each other by a separation height of less than 5 millimetres defined in a z direction. In this example, the separation height is 3.2 millimetres.

The aerosol-generating article 100 comprises an air inlet 240, an air outlet 260, and an airflow passage extending between the air inlet and the air outlet. The airflow passage is defined between the planar upper layer 110 and the planar lower layer 120. The airflow passage has a width of greater than 1 millimetre, defined in a y direction. In this example, the width of the airflow passage is 2.5 millimetres, and it is uniform along the length of the airflow passage. The airflow passage has a passage height defined in the z direction, wherein the passage height is equal to the separation height.

The planar upper layer 110 comprises a upper external surface and the planar lower layer 120 comprises a lower external surface, the upper external surface and the lower external surface are vertically spaced by a surface-to-surface height. In this embodiment, upper external surface of the planar upper layer 110 is an upper external surface of the aerosol-generating article 100 and the lower external surface of the planar lower layer 120 is a lower external surface of the aerosol-generating article 100, as such the surface-to-surface height in this embodiment is equal to the height (which may also be referred to as a thickness) of the aerosol-generating article, extending in the z direction.

The aerosol-generating article 100 has a length, extending in an x dimension, of 40 millimetres, a width, extending in a y dimension, of 15 millimetres, and a height (which may also be referred to as a thickness), extending in a z dimension, of 3.6 millimetres. The cross-sectional sectional area of the airflow passage is 8 millimetres squared. The length of the airflow passage is equal to the length of the aerosol-generating article, so the volume of the airflow passage is 320 millimetres cubed.

An air flow path 230 is defined through the aerosol-generating article 100 between the planar upper and lower layers 110, 120. The air flow path 230 extends between opposed first and second ends 201, 202 of the aerosol-generating article 100. The first end 201 may define a distal end of the aerosol-generating article 100, and the second end 202 may define a proximal end of the aerosol-generating article. The air flow path 230 extends between the air inlet 240, the air outlet 260 and through the air flow passage of the aerosol-generating article. The air flow path 230 may be directed towards a mouth of a user to allow a user to inhale aerosol generated in consequence of heating of aerosol-forming substrate of the aerosol-generating article 100.

As shown in FIGS. 1a and 1b, the air inlet 240 and the air outlet 260 both have rectangular cross-section in the z-y direction, the airflow passage has a corresponding cross-section (not shown in FIGS. 1a and 1b) and is formed or a single airflow channel extending between the air inlet 240 and the air outlet 260.

The aerosol-generating article 100 is configured to be used as part of an aerosol-generating system. The aerosol-generating system comprises an aerosol-generating device configured to engage with, and generate an aerosol from, the aerosol-generating article 100. The aerosol-generating device may comprises a heater for heating aerosol-forming substrate within the aerosol-generating article.

FIGS. 2, 3, and 4 illustrate respectively an end view, a side view, and a plan view of an aerosol-generating article 300 according to a second embodiment of the present disclosure. The aerosol-generating article 300 comprises a planar upper layer 310, a planar lower layer 320, and an intermediate or separation layer 340 arranged between the upper layer 310 and lower layer 320. The planar upper layer 310 and the planar lower layer 320 are vertically spaced from each other by a separation height of less than 5 millimetres defined in a z direction.

The planar upper layer 310 is formed from a sheet of paper having a thickness of 300 microns. The planar lower layer 320 is formed from a sheet of paper having a thickness of 300 microns. The intermediate layer 340 is a corrugated element formed from a corrugated sheet of aerosol-forming substrate 345. A suitable aerosol-forming substrate may be homogenised tobacco. Thus, the intermediate layer 340 may be formed from a corrugated sheet of homogenised tobacco material 345.

FIG. 5 illustrates the corrugated sheet of aerosol-forming substrate 345. The corrugations have an amplitude 346 of 3 millimetres, equal to the separation height, and a wavelength 347 of 3 millimetres. The sheet of aerosol-forming substrate 345 forming the intermediate layer 340 has a thickness of 150 microns.

Points of intersection 351, 352 between the upper layer 310 and the intermediate layer 340 and between the lower layer 320 and the intermediate layer 340 comprise an adhesive that joins the respective layers.

The aerosol-generating article 300 has a length, extending in an x dimension, of 40 millimetres, a width, extending in a y dimension, of 15 millimetres, and a height (or thickness), extending in a z dimension, of 3.6 millimetres.

Corrugations of the intermediate layer 340 form a first set of longitudinally extending channels 361 that are bounded by the upper layer 310 and the intermediate layer 340, and a second set of longitudinally extending channels 362 bounded by the lower layer 320 and the intermediate layer 340. The first and second sets of longitudinally extending channels 361, 362 extend through the length of the aerosol-forming substrate between a proximal end 371 of the substrate 345 and a distal end 372 of the substrate 345. The longitudinally extending channels 361, 362 define an airflow path through the substrate 345. The airflow path, therefore, passes over both sides of the sheet of aerosol-forming substrate 345. The porosity of the aerosol-generating article along the air-flow path is in the region of 90 percent. This provides a very low resistance to draw (RTD) of less than 5 mm H₂O. In fact, the RTD is close to zero. The air-flow path is defined by an air flow passage. The plurality of longitudinally extending channels 361, 362 together form the airflow passage, extending between an air inlet and an air outlet. Each longitudinally extending channel extends between a channel air inlet and a channel air outlet. Each of the channel air inlets together form the air inlet of the aerosol-generating article and each of the channel air outlets together form the air outlet of the aerosol-generating article.

The width of the airflow passage is a cumulative width of each of the channel widths of plurality of longitudinally extending channels 361, 362. In this embodiment, the cumulative width of each of the channel widths of plurality of longitudinally extending channels 361, 362 is the total width of the intermediate layer 340 in the y direction, minus two times the thickness of the corrugated element for each wavelength. In this embodiment, the width of the airflow passage is 14.1 millimetres.

The cross-sectional area of the airflow passage in the y-z direction is the cumulative cross-sectional area of all of the cross-sectional areas of the plurality of longitudinally extending channels 361, 362 in the y-z direction. In this example, the airflow passage cross-sectional area is therefore the cross-sectional area of the aerosol-generating article in the y-z dimension, minus the cross-sectional area of the intermediate layer 340, minus the cross-sectional area of the upper layer 310 and the lower layer 320, in the y-z dimension, which is 43.65 millimetres squared.

The aerosol-forming substrate 345 may be a sheet of any suitable aerosol-forming substrate.

During use of the aerosol-generating article 300, the aerosol-forming substrate 345 is heated up to cause the aerosol-forming substrate 345 to release volatile compounds, which are then entrained in air drawn into the channels 361, 362 via the distal end 372. The volatile compounds then cool and condense to form an aerosol which may be drawn out of the channels 361, 362 of the aerosol-generating article 300 via the proximal end 371.

FIG. 6 shows an aerosol-generating article 400 according to a third embodiment of the present disclosure. The aerosol-generating article 400 comprises a planar upper layer 424 forming a first planar external surface 421, a planar lower layer 425 forming a second planar external surface 422, the planar upper layer 424 and the planar lower layer 425 are vertically spaced from each other by a separation height defined in a z direction. A frame 450 is positioned between the first planar external layer 424 and the second planar external layer 425. The second planar external surface 422 is positioned parallel to the first planar external surface 421.

FIGS. 7 and 8 show exploded views of the aerosol-generating article 400 of FIG. 6. The frame 450 circumscribes and at least partially defines a cavity 430. FIG. 7 shows the cavity 430 in an empty state. FIG. 8 shows the cavity 430 filled with aerosol-forming substrate 440. FIGS. 9 and 10 show respective transverse and longitudinal cross-sectional views of the aerosol-generating article 400 when the cavity 430 is filled with aerosol-forming substrate 440.

The planar upper layer 424 and the planar lower layer 425 are made from cigarette paper having a thickness of 35 micrometres and are in physical contact, with and bonded to, the frame 450. The planar upper layer 424 overlies a first end of the cavity 430 and forms a first cavity end wall 431. The planar lower layer 425 overlies a second end of the cavity 430 and forms a second cavity end wall 432, the second cavity end wall 432 being opposite to the first cavity end wall 431. That is, the frame 450, the planar upper layer 424 and the planar lower layer 425 collectively define the cavity 430.

The frame 450 has a hollow cuboid shape and is made from cardboard. The frame 450 defines an aperture extending through the height (also referred to as the thickness) of the frame 450 and the aperture at least partially forms the cavity 430 of the aerosol-generating article 400. The frame 450 comprises a peripheral wall 451 that circumscribes the cavity 430. The peripheral wall 451 includes a front wall 413 and a back wall 414. In more detail, the peripheral wall 451 is defined by an inner transverse surface 452 of the frame 450 and an outer transverse surface 453 of the frame 450. The inner transverse surface 452 of the peripheral wall 451 at least partially defines a perimeter of the cavity 430. The outer transverse surface 453 of the peripheral wall 451 at least partially defines a perimeter of the aerosol-generating article 400. The peripheral wall 451 has a radial thickness measured between the inner transverse surface 452 of the frame 450 and the outer transverse surface 453 of the frame 450 of about 5 millimetres.

An air inlet 411 and an air outlet 412 are defined by, and extend through, the peripheral wall 451 of the frame 450. More specifically, the air inlet 411 extends through the front wall 413 and the air outlet 412 extends through the back wall 414. The air inlet 411 and the air outlet 412 have an equivalent diameter of 5 millimetres. An airflow passage extends between the air inlet 411 and the air outlet 412 through the cavity 430. As shown in FIGS. 8 to 10, an aerosol-forming substrate 440 is positioned within the cavity 430. The aerosol-forming substrate 440 comprises an aerosol-generating material in the form of tobacco cut filler and has an aerosol-former content of 5 percent by weight on a dry weight basis. As shown, the aerosol-forming substrate 440 fills the entire volume of the cavity 430.

The aerosol-generating article 400 has a cuboid shape and has a height (or thickness) extending in a z dimension, as measured between the first planar external surface 421 and the second planar external surface 422, of 5 millimetres, a width extending in a y dimension of 40 millimetres and a length extending in an x dimension of 60 millimetres. The frame 450 has a height (or thickness) extending in a z dimension of 4.93 millimetres, which is equal to a separation height defining the vertical spacing between the planar upper layer 424 and the planar lower layer 425. The frame has a width extending in a y dimension of 40 millimetres and a length extending in an x dimension of 60 millimetres. The cavity 430 has a height (or thickness) extending in a z dimension of 4.93 millimetres, which is equal to the separation height and the height of the airflow passage, and a width extending in a y dimension of 39.93 millimetres and a length extending in an x dimension of 52 millimetres.

In this embodiment, the width of the air inlet 411 and the width of the air outlet 412 are not equal to the width of the cavity 430. The width of the airflow passage may be defined as the width of the cavity 430. Therefore, the width of the airflow passage is 39.93 millimetres.

FIG. 11 shows an aerosol-generating article 500 according to a fourth embodiment of the present disclosure. Features in common with aerosol-generating article 400 are referred to with like reference signs. Aerosol-generating article 500 differs from aerosol-generating article 400 in that the aerosol-forming substrate is in the form of a sheet of aerosol-generating material 540, in particular a corrugated sheet of homogenised tobacco material. FIGS. 12 and 13 show respective transverse and lateral cross-section views of the aerosol-generating article 500 of FIG. 11.

The corrugated sheet of homogenised tobacco material 540 comprises a plurality of parallel corrugations having a plurality of substantially parallel peaks 543 and troughs 544. The plurality of parallel corrugations are defined by a corrugation profile which, as seen in FIG. 12, is sinusoidal. The plurality of parallel corrugations have a corrugation wavelength of about 4.6 millimetres. The corrugation amplitude is approximately the same as the height (or thickness) of the cavity 430, as shown by the peaks 543 and troughs 544 coinciding with the first cavity end wall 431 and the second cavity end wall 432, respectively. The corrugated sheet of homogenised tobacco material 540 has a thickness of 150 microns.

The plurality of parallel corrugations form a plurality of channels 545 between the sheet of aerosol-generating material 540 and the first cavity end wall 431, and a plurality of channels 546 between the sheet of aerosol-generating material 540 and the second cavity end wall 432. The plurality of channels 545, 546 extend in a longitudinal direction of the aerosol-generating article 500 and form at least a portion of the airflow passage extending between the air inlet 411 and the air outlet 412.

Each channel of the plurality of channels 545, 546 has a channel width. As the width of the channel is not constant in the z direction, the channel width may be taken as an average width of the channel in the z direction.

The width of the airflow passage is a cumulative width of each of the channel widths of the plurality of longitudinally extending channels 545, 546. In this embodiment, the width of the air flow passage is the width of the cavity 430 minus the thickness of the aerosol-forming material 540 for each peak and trough. In other words, the width of the air flow passage is the cumulative width of the space available for air flow through the cavity. In this example, the width of the air flow passage is 37 millimetres.

The cross-sectional area of the airflow passage in the y-z direction is the cumulative cross-sectional area of all of the cross-sectional areas of the plurality of longitudinally extending channels 545, 546 in the y-z direction.

During use of each of the aerosol-generating articles 400, 500, the aerosol-forming substrate 440, 540 is heated up to cause the aerosol-forming substrate 440, 540 to release volatile compounds, which are then entrained in air drawn through the air inlet 411 into the cavity 430. The volatile compounds then cool and condense to form an aerosol which may be drawn out the aerosol-generating article 400, 500 through the air outlet 412.

For exemplary purposes applicable to any of the embodiments described above, a composition of a suitable aerosol-forming substrate may be as follows. Percentages are given in weight percent with respect to the product in its final state. The aerosol-forming substrate may have a moisture of about 5 to 25%, preferably of about 7 to 15%, at final product state. The aerosol-forming substrate may further comprise the following:
1. Tobacco leaf; for example about 15 to 45%, preferably of about 20 to 35% of a blend of tobacco leaf, incorporating at least one of the following tobacco types: bright tobacco; dark tobacco; aromatic tobacco. Tobacco material is ground and graded to a particle size of about 100 to 380 mesh, preferably of about 170 to 320 mesh.
2. Cellulose fibres; for example about 1 to 15%, preferably of about 3 to 7%, of cellulose fibres, of a length of about 10 to 250 μm, preferably of about 10 to 120 μm.
3. Tobacco fibres; for example about 5 to 20%, preferably of about 7 to 15% of tobacco fibres, as filler, of any tobacco type or a blend of tobacco types. Tobacco fibres are preferably derived from stems and/or or stalks, graded to fibres of a length of about 10 to 350 μm, preferably of about 10 to 180 μm.
4. Binder; for example about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. The preferable binder is guar.
5. Aerosol-former; for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di- or triacetate; and aliphatic esters of mono-, di- or polycarboxylic acids, such as dimethyls of those.

“Tobacco type” means one of the different varieties of tobacco, for example based on the distinct curing process that the tobacco undergoes before it is further processed in a tobacco product.

For exemplary purposes, a composition of a further aerosol-forming substrate, which may also be suitable for use as the aerosol-forming substrate in any of the embodiments described above is described below. Percentages are given in weight percent with respect to the product in its final state. The aerosol-forming substrate may comprise:
1. An aerosol-former such as Glycerin; for example about 10 to 40 %, preferably of about 20 to 30 %.
2. Organic fibres; for example about 10 to 30 %, preferably of about 15 to 25%, of any botanical variety suitable and with purity to comply with applicable FDA F&B grade requirements, as commonly available in the market. For example, organic fibres may derive from cellulose, cotton, wood, tea botanical varieties as sub-products, and sub-processed waste, of F&B tea industry. Organic fibres are preferably of a length of about 10 to 400 μm, preferably of about 10 to 200 μm.
3. Organic botanical glycerite; for example about 15 to 55 %, preferably of about 20 to 35 %, of botanicals such as Clove, Echinacea sp., Fennel, Ginger, Hawthorn berry, Elderberry, Monarda, Mullein leaves, Nettle, Plantain, Turmeric, Yarrow, and compounds of those.
4. Organic botanical extracts; for example about 1 to 15 %, preferably of about 2 to 7 %, of any of the previously referred botanicals, as well as menthol (dl-Menthol, C10H20O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

Alternatively, such aerosol-forming substrate may also contain botanical essential oils of about 0.5 to 5 %, preferably of about 1 to 3 %, such as of palm, coconut, and wooden-based essential oils.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein. The terms “in which” and “wherein” are used synonymously through this specification.

1.-15. (canceled)

16. An aerosol-generating article for an aerosol-generating device to generate an inhalable aerosol, the aerosol-generating article comprising:
a planar upper layer and a planar lower layer vertically spaced from each other by a separation height defined in a z direction; and
an air inlet, an air outlet, and an airflow passage extending between the air inlet and the air outlet, the airflow passage being defined between the planar upper layer and the planar lower layer and having a width defined in a y direction,
wherein the width of the airflow passage is greater than 1 millimetre, the separation height is less than 2 millimetres, and the aerosol-generating article has a resistance to draw (RTD) of less than 20 millimetres H₂O in a direction of the airflow passage.

17. The aerosol-generating article according to claim 16, wherein the airflow passage has a passage height defined in the z direction and the passage height is equal to the separation height.

18. The aerosol-generating article according to claim 16, wherein the separation height is less than 1 millimetre.

19. The aerosol-generating article according to claim 16, wherein the separation height is greater than 0.1 millimetre.

20. The aerosol-generating article according to claim 16, wherein the width of the airflow passage is greater than 1.2 millimetres.

21. The aerosol-generating article according to claim 16, wherein the width of the airflow passage is less than 3 millimetres.

22. The aerosol-generating article according to claim 16,
wherein the airflow passage has a cross-sectional area defined in the y, z direction, and
wherein the cross-sectional sectional area of the airflow passage is greater than 0.1 millimetre squared and less than 15 millimetres squared.

23. The aerosol-generating article according to claim 16,
wherein the airflow passage has a length defined in an x direction, and
wherein the length is greater than 15 millimetres and less than 40 millimetres.

24. The aerosol-generating article according to claim 16, wherein the RTD is less than 10 millimetres H₂O in the direction of the airflow passage.

25. The aerosol-generating article according to claim 16, wherein the width of the airflow passage is an average width of the airflow passage, defined in the y direction, across the separation height.

26. The aerosol-generating article according to claim 16, wherein the width of the airflow passage is uniform along the separation height.

27. The aerosol-generating article according to claim 16, wherein a cross-section of the airflow passage defined in the y, z direction is square or rectangular.

28. The aerosol-generating article according to claim 16,
wherein the aerosol-generating article has an article width defined in the y direction, and
wherein the width of the airflow passage is at least 0.1 times the article width.

29. The aerosol-generating article according to claim 16, wherein the air flow passage is formed of a single airflow channel extending between the air inlet and the air outlet.

30. The aerosol-generating article according to claim 16,
wherein a plurality of discrete air flow channels together form the airflow passage,
wherein each discrete air flow channel of the plurality of discrete air flow channels has a channel width, and
wherein the width of the airflow passage is a cumulative width of each of the channel widths.

31. The aerosol-generating article according to claim 16, wherein the planar upper layer, the planar lower layer, or both the planar upper layer and the planar lower layer comprise an aerosol forming substrate.
